(19) United States
(12) Patent Application Publication
(10) Pub. No.: US 2007/0185601 A1
(43) Pub. Date: Aug. 9, 2007

(54) Presentation of audible media in accommodation with external sound

(75) Inventors: Michael M. Lee, San Jose, CA (US); John Arthur, Santa Clara, CA (US)

Correspondence Address: BEYER WEAVER LLP, P.O. BOX 70250, OAKLAND, CA, 94612-0250, US

(73) Assignee: Apple Computer, Inc.

(21) Appl. No.: 11/349,619

(22) Filed: Feb. 7, 2006

(51) Int. Cl. G06F 17/00

(52) U.S. Cl. 700/94

(57) ABSTRACT

Sound (e.g., traffic, noise) that is effectively blocked or reduced by an audio device is presented alone or in combination with audible and/or visual media. Typically, sound that is external to presentation of, for example, digitally stored audible media (e.g., digitally stored audio files) is reduced or blocked when audio is presented via an audio-output device (e.g., headphones). This external sound can be presented to users via the same interface, channel, or audio-output device used to present audio-media. External sound can be blended (or combined) with audible media and/or it may be presented as it occurs (live) and/or stored so that it can be subsequently presented as recorded (e.g., digital data). External sound can be stored independent of the media presentation in accordance with, for example, various events, user input, or any other programmable criteria.

### BACKGROUND OF THE INVENTION

Media players present one or more forms of media (e.g., audio, video, audio-visual). Some media players (e.g., cassette players, CD players) are used for presentation of a single form of media (e.g., sound). However, other media players (e.g., digital media players, DVD players) can effectively present multiple forms of media via various audio (e.g., speakers, headphones) and video output devices (e.g., CRT displays).

Electronic devices that present media have been generally popular for some time now. Digital media players (e.g., portable music players or MP3 players) have become especially popular partly because they can store media as digital data and present media in numerous forms including audible, visual, and audio-visual forms. Digital data can be transported electronically, for example, as digital files or digital streams. Digital data can be accessed by a variety of computing devices available today (e.g., personal computers, media players, personal assistants, wireless phones). Typically, digital media includes at least digital content (or “content”) that represents that actual content of information stored in a digital form. As such, digital content can, for example, be the content of a printed book, a song in audible form and/or in audio-visual forms (e.g., a video), movies, sports broadcasts, news in a variety of forms including text, audio, or audio-visual.

### SUMMARY OF THE INVENTION

Broadly speaking, the invention relates to techniques for improved presentation of media. In accordance with one aspect of the invention, sound that is effectively blocked or reduced by an audio device, such as external sound, can be presented alone or in combination with audible and visual media. Typically, external sound is or would be external to a media presentation provided by the media device. It will be appreciated that, in one embodiment, external sound can be presented to users, for example, via the same interface, channel, or audio-output device (e.g., headphones, loud-speakers) used to present medias (e.g., music). This interface, channel or audio-output device can also effectively reduce the external sound. As a result, users of the audio devices can conveniently switch between external sound and audible media (e.g., without having to take headphones off). Furthermore, external sound and audible media can presented or at the same time. In effect, external sound (e.g., traffic noise) can be blended (or combined) with audible media and presented via, for example, the same interface channel, or audio-output device. It should be noted that external sound may be presented as it occurs (live) and/or stored so that it can be subsequently presented as recorded sound. It should also be noted that external sound can be stored independent of the media presentation in accordance with, for example, various events, user input, or programmable conditions.

In accordance with one embodiment of the invention, a digital media player can present both media and external sound via the same audio-output device (e.g., headphones). During presentation of media, the user can request presentation of external sound (e.g., by pressing a pause button). Depending on user's preference, at least the audio-portion of the media being presented is automatically adjusted (e.g., volume is lowered, audible media is effectively paused) to accommodate presentation of the external sound. This allows the user to use the headphones to listen, for example, to an announcement being made by the pilot, converse with flight attendants or other passengers without having to take the headphones off. In addition, the media player can automatically resume the presentation of the media upon request (e.g., by pressing the pause again). It will be appreciated that external sound and digitally stored audible media (e.g., music files) can be combined (or blended) and presented to the user via the headphones in accordance with user input or various other programmable criteria. It will also be appreciated that the media player can also store external sound as digital data and present it to the user with various play-back functions (e.g., pause, forward, backward, skip) that digital media players normally provide in connection with presentation of digital media. As such, users can configure the media player to effectively store the external sound while media is being presented to them. The user can later listen to the stored external sound when it is convenient. In addition, the use can conveniently go over the stored external sound with play-back functionality similar to that provided by digital media players.

The invention can be implemented in numerous ways, including a method, an apparatus, a computer readable medium, a computing device, or a signal embodied in a carrier wave. Several embodiments of the invention are discussed below.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, wherein like reference numerals designate like structural elements, and in which:

FIG. 1 depicts a device equipped with a media and external sound presenter capable of presenting media (e.g., digital data) and/or external sound 106 in accordance with one embodiment of the invention.

FIG. 2A depicts a method 200 for controlling a media-presentation-environment in accordance with one embodiment of the invention.

FIG. 2B depicts a presentation method 206 for presenting external sound with or without any media in accordance with one embodiment of the invention.

FIG. 3 depicts a device capable of presenting external sound and/or stored digital data in accordance with one embodiment of the invention.

FIG. 4 depicts a media player in accordance with one embodiment of the invention.

FIG. 5 depicts a method for presenting external sound and media in accordance with one embodiment of the invention.

### DETAILED DESCRIPTION OF THE INVENTION

As noted in the background section, media players present one or more forms of media. Typically, audio is presented via an audio-output device (e.g., set of speakers or headphones). Presentation of audio effectively blocks or reduces the sound that is external to the audio being presented (external sound). This reduction or blockage of external sound (e.g., sound of traffic, noise, sound of people conversing) is especially effective, for example, when headphones or similar devices are used alone or in connection with ear-buds. In fact, when headphones alone or in combination with ear-buds are used external noise is effectively reduced regardless of whether audio is being presented. Of course, external sound is more effectively blocked when audio is presented especially at higher volumes. In any case, external sound can be effectively reduced or blocked when audio is presented and/or noise-reducing devices (e.g., ear buds, headphones, headphones and ear buds) are used.

Although reduction of external sound is often desirable or at least tolerable, conventional techniques for presentation of audio conventional noise-reduction devices (e.g., headphones, ear-buds) do provide a convenient way to hear the external sound when it is desirable to do so. By way of example, a media player has to be stopped and/or headphones have to be taken off when a user who is listening to music, while traveling on a plane, wants to hear an announcement by the pilot. This limitation has proved to be more than an inconvenience when, for example, headphones are used to listen to music in busy street, where the sound of a horn or other warning signs can be completely blocked. With ever increasing popularity of digital media, alternative techniques for presentation of media have become even more useful.

Accordingly, the invention pertains to techniques for presentation of media. In accordance with one aspect of the invention, sound that is effectively blocked or reduced by an audio device (external sound) is presented alone or in combination with audible and visual media. Typically, external sound is or would be external to media presentation. It will be appreciated that external sound can be presented to users, for example, via the same interface, channel, or audio-output device (e.g., headphones, loud-speakers) used to present medias (e.g., music). This interface, channel or audio can also effectively reduce the external sound. As a result, users of the audio-devices can conveniently switch between external sound and audible media (e.g., without having to take headphones off. Furthermore, external sound and audible media can presented or at the same time. In effect, external sound (e.g., traffic noise) can be blended (or combined) with audible media and presented via, for example, the same interface channel, or audio-output. It should be noted that external sound may be presented as it occurs (live) and/or stored so that it can be subsequently presented as recorded sound (e.g., digital data). It should also be noted that external sound can be stored independent of the media-presentation in accordance with, for example, various events, user input, or programmable conditions.

In accordance with one embodiment of the invention, a digital media player can present both media and external sound via the same audio-output device (e.g., headphones). During presentation of media, the user can request presentation of external sound (e.g., by pressing a pause button). Depending on user's preference, at least the audio-portion of the media being presented is automatically adjusted (e.g., volume is lowered, audible media is effectively paused) to accommodate presentation of the external sound. This allows the user to use the headphones to listen, for example, to an announcement being made by the pilot, converse with flight attendants or other passengers without having to take the headphones off. In addition, the media player can automatically resume the presentation of the media upon request (e.g., by pressing the pause again). It will be appreciated that external sound and digitally stored audible media (e.g., music files) can be combined (or blended) and presented to the user via the headphones in accordance with user input or various other programmable criteria. It will also be appreciated that the media player can also store external sound as digital data and present it to the user with various play-back functions (e.g., pause, forward, backward, skip) that digital media players normally provide in connection with presentation of digital media. As such, users can configure the media player to effectively store the external sound while media is being presented to them. The user can later listen to the stored external when it is convenient and conveniently go over it with the play-back functionality that can be provided for stored digital data.

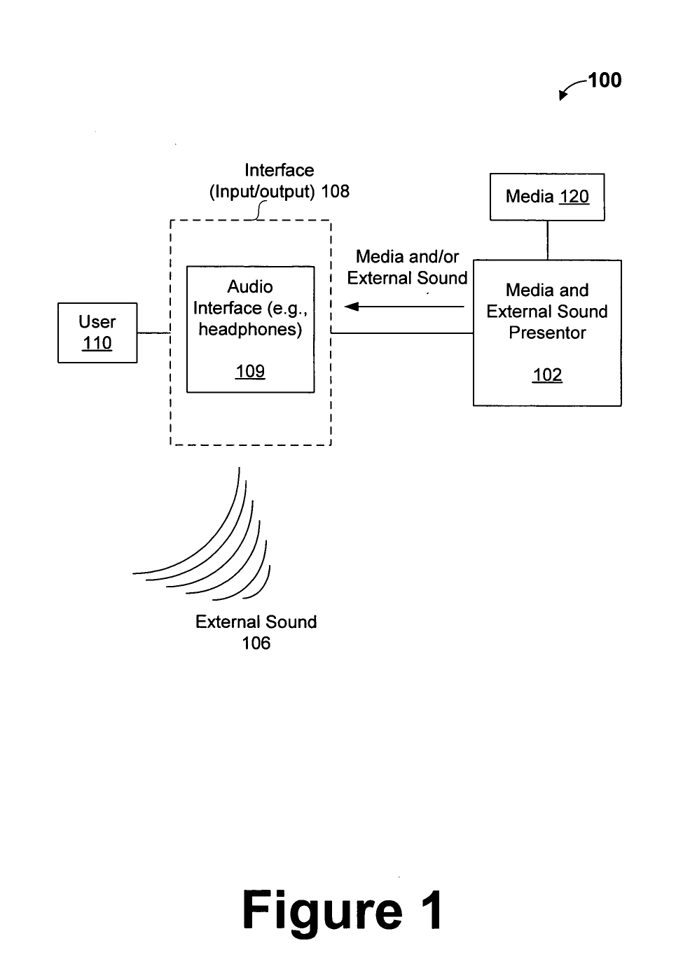

Embodiments of these aspects of the invention are discussed below with reference to FIGS. 1-5. However, those skilled in the art will readily appreciate that the detailed description given herein with respect to these figures is for explanatory purposes as the invention extends beyond these limited embodiments.

FIG. 1 depicts a device 100 equipped with a media and external sound presenter 102 capable of presenting media (e.g., digital data) 120 and/or external sound 106 in accordance with one embodiment of the invention. It will be appreciated that the media-and-external-sound-presenter 102 can effectively control presentation of media 120 and/or external sound 106 which are provided via an audio interface 109 (e.g., headphone, earbuds, etc.). As shown in FIG. 1, the audio interface 109 can be part of a larger interface (input/output) 108. As such, interface 108 can, for example, include additional input/output components (e.g., display, keyboard, mouse). It should be noted that the audio interface 109 (e.g., headphones) can effectively reduce or block the external sound 106 (e.g., natural sounds) that would normally be audible to user 110 when audio interface (e.g., headphones) 109 is not in use. Typically, external sound 106 is not initially stored as recorded and/or digital data and would be external (or natural) sound with respect to presentation of media 120.

External sound 106 can also occur independently of the presentation of the media 120. By way of example, external sound 106 can be noise or natural sounds (e.g., people conversing, traffic noise, ring of a telephone) that would be normally audible to user 110, but are effectively blocked or reduced when audio interface 109 is in use. It should be noted that it is possible that the audio interface 109 effectively blocks or reduces external sound 106 regardless of whether media is being presented or not via the audio interface 109. Typically, external sound 106 is more effectively reduced or blocked when media is presented via the audio interface 109 by virtue of the fact that presentation of media 126 makes the external sound 106 less audible when the user 110 is listening to the audio interface 109 (e.g., when user is wearing headphones and listening to music).

In any case, media and external sound presenter 102 can present media and/or the external sound 106 via the same media audio interface 109. External sound 106 can be presented with or without media 120. In other words, external sound 106 can be presented above or it can blended with media 120 and presented to the user 110 via the audio interface 109. Typically, user 110 can request that external sound 106 be presented (e.g., by pressing an input button). The external sound 106 can be presented in accordance with one or more presentation parameters (e.g., volume) which are defined and/or input by the user 110. Accordingly, the media and external sound presenter 102 can be configured to receive user input and/or automatically initiate presentation of external sound 106 when, for example, external noise that meets or exceeds a quantifiable parameter is detected, periodically, or when any other programmable condition has been met. As will be described below, the presentation of the media 120 can be adjusted when external sound 106 is presented or is to be presented.

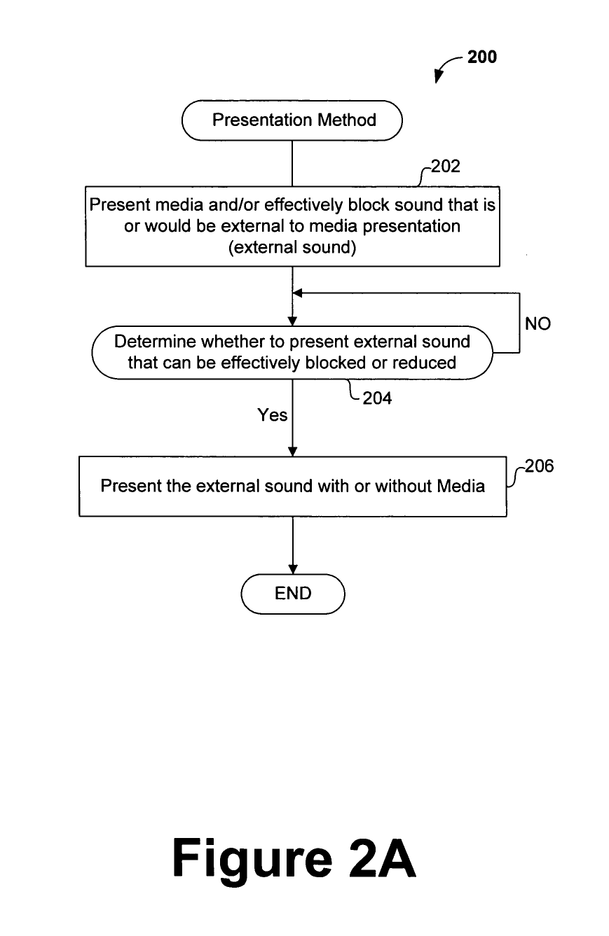

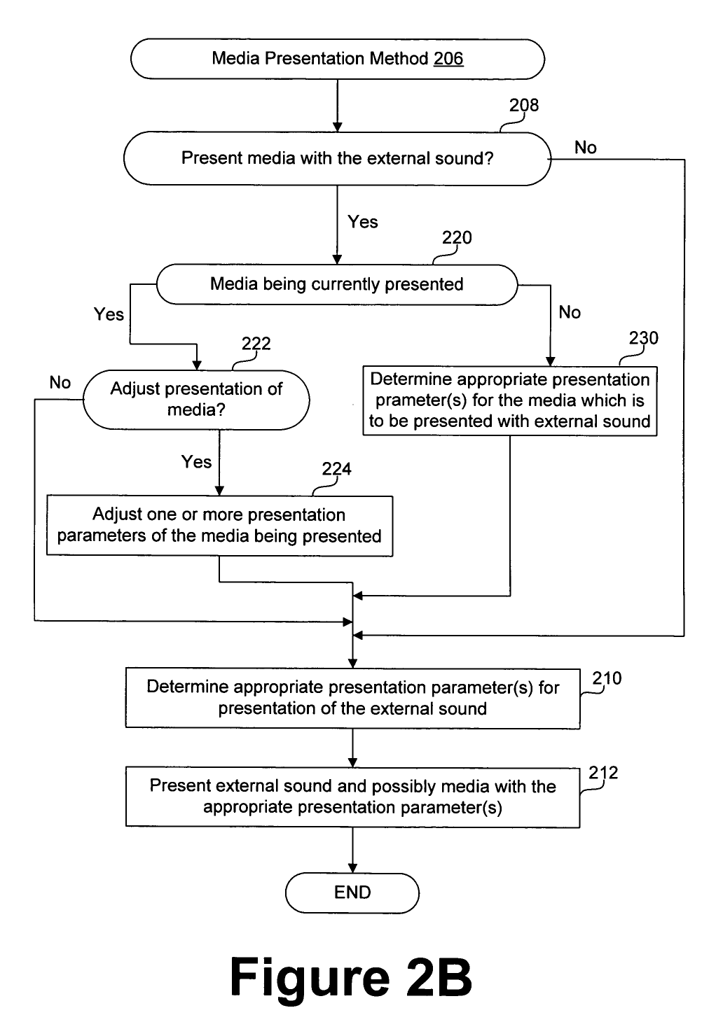

Referring now to FIG. 2A, depicts a method 200 for controlling a media-presentation-environment is depicted in accordance with one embodiment of the invention. Method 200 can, for example, be used by the media-and-external-sound-presenter 102 shown in FIG. 1. Initially, media is presented and/or sound which is or would be external to presentation of media (external sound) is effectively blocked or reduced (202). Next, it is determined (204) whether to present the external sound which can effectively blocked or reduced. As suggested above, this determination (204) can, for example, be made based on user input, a timer, or condition, event, or any other programmable criteria that would trigger presentation of external sound. Accordingly, if it is determined (204) to present the external sound, external sound is presented (206) with or without media, and the method 200 ends presentation (206) is discussed below.

To further elaborate, FIG. 2B depicts a presentation method 206 for presenting external sound with or without media in accordance with one embodiment of the invention. Referring now to FIG. 2B, initially, it is determined (208) whether to present any media with the external sound. Again, this determination (208), for example, be made based on user input, configuration provided by the user, or any other programmable criteria. In any case, if it is determined (208) not to present media with the external sound (e.g., external sound is to be presented without any media), appropriate presentation parameter(s) for presentation of the external sound is determined (210). Subsequently, the external sound is presented (212) without media, and the presentation method 206 ends.

On the other hand, if it is determined (208) to present media with external sound, it is determined (220) whether the media is being currently presented. If it is determined (220) that media is currently being presented, it is determined (222) whether to adjust the presentation of media so that the media can be presented with the external sound (e.g., presenting media and external sound together at the same time) via the same output device. Accordingly, media presentation can be adjusted (224). Typically, at least the volume associated with the media presentation is lowered to accommodate presentation of external sound. However, it will be apparent that both audio and visual presentation of media can be adjusted as deemed appropriate. For example, it is possible to stop presentation of a movie or just lower the sound.

In any case, after one or more presentation parameters have been adjusted (224), the appropriate presentation parameter(s) for presentation of external sound are determined (210). Thus, after adjusting (224) of the media and determining (210) of the presentation parameter(s) for the external sound, media and external sound can be, for example, effectively blended together as desired (e.g., 80% external sound, 20% audible media with visual media playing). In general, the external sound and media are presented (212) with the appropriate presentation parameters. The method 200 ends following the presentation (212) of the external sound and media.

However, if it is determined (220) that media is not currently being presented, but it is to be presented with the external sound, appropriate presentation parameters for presentation of the media is determined (230) Instead of adjusting (222) the presentation of media. Thereafter, method 200 proceeds in a similar manner as described above to determine (210) the appropriate presentation parameter(s) for the external sound and present it with any media. It should also be noted that the adjusting (224) of the media parameters or determining (230) of the media parameters may result in reducing or completely shutting off the audio presentation of media (212) (e.g., leaving the visual presentation of a movie on while audio is turned off).

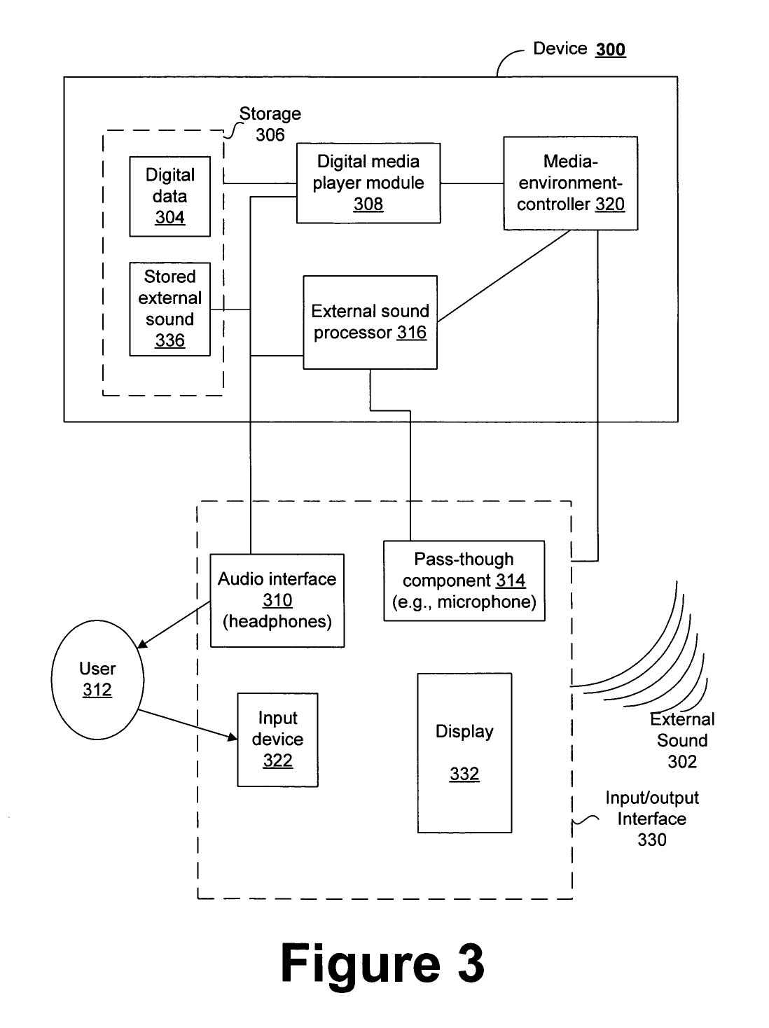

FIG. 3 depicts a device 300 capable of presenting external sound 302 and/or stored digital data 304 in accordance with one embodiment of the invention. Stored digital data 304 can be presented (e.g., played) by a digital media player module 308 (e.g., a media player software module) via an audio interface 310 (e.g., headphones) provided for a user 312. In addition, external sound 302 can be received via a pass-through component (e.g., a microphone 314), processed by an external sound processor 316 and presented via the same audio interface 310 used to present the digital data 304. It should be noted that the external sound 302 can be stored in storage 306 as digital data (stored external sound 336).

The stored external sound 336 can effectively be presented by the external sound processor 316 which can provide a complete set of media-presentation functions, media player functionality including playback functionality (e.g., forward, skip, pause). In order to control presentation of external sound 302 and digital data 304, a media-environment-controller 320 communicates with the digital media player 308 and external sound processor 316. The media-environment-controller 302 effectively controls the presentation parameters for presenting digital data 304, stored external sound 336, and external sound 302 as passed through by the pass-through component 314. User 312 can interface with an input device 322 (e.g., keyboard, key, button, mouse) to effectively request presentation of digital data 304, external sound 302, and/or stored external sound 336 presentation parameters. Input device 322 can be part of an input/out interface 330 that includes additional components such as display 332. User 312 can, for example, configure the device 300 to store the external sound 302 as desired. External sound 302 can, for example, be stored for a determined amount of time (e.g., 5, 10, 60 seconds) and made available to the user upon request. In other words, the user can request to hear the external sound 302 (e.g., natural sound) that was, for example, received 5, 10, or 60 seconds ago when the user 312 was listening to digital data 304. By way of example, external sound 302 can be stored in one or more buffers and/or can be buffered for a determined amount of time (e.g., 3 minutes).

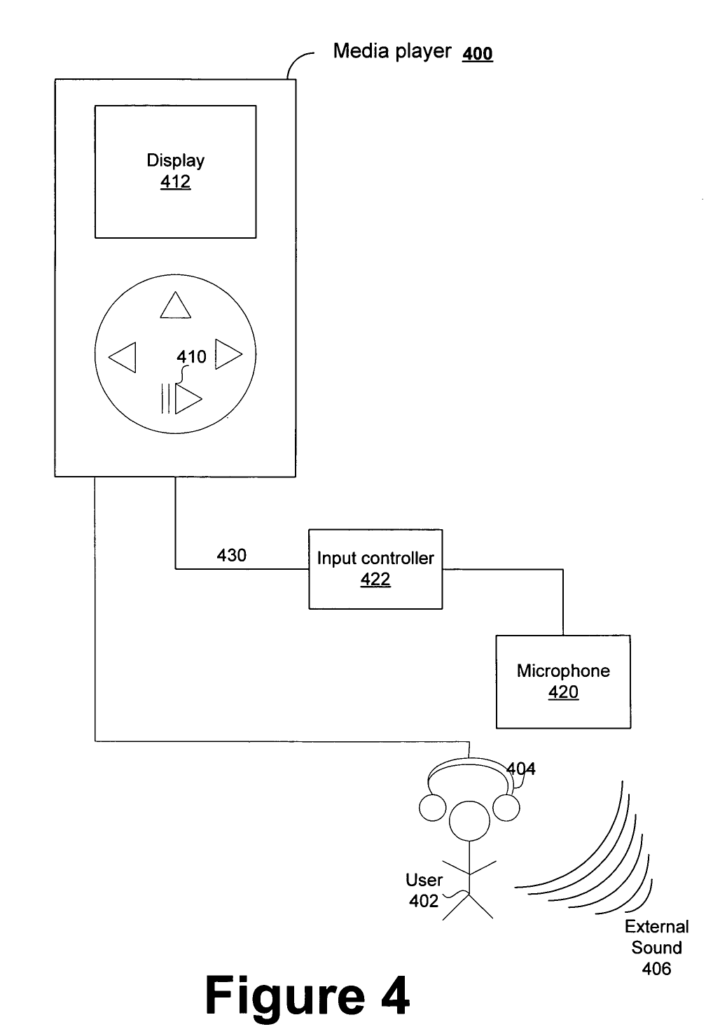

FIG. 4 depicts a media player 400 in accordance with one embodiment of the invention. The media player can, for example, be an Apple iPod media player that, among other things, controls a user's (102) environment with respect to presentation of media and external sound 406. The user 402 can listen to audio by placing a set of headphones 404. The set of headphones 404 effectively block or reduce the external sound 406 (e.g., outside noise) that would be otherwise audible to user 402. Typically, headphones 404 are used in order to listen to audio. However, headphones 404 alone or in combination with earbuds can be used primarily for blocking or reducing the external sound 406 without listening to audio media being presented.

In any case, when headphones 404 are in use, external sound 406 is at least reduced. However, user 402 can request to be presented with the external sound 406 via the headphones 404 without having to take the headphones 404 off. This request can, for example, be made by pressing a key (e.g., pause key) 410. Typically, the request for presentation of external sound 406 is made when audio is currently being presented via the headphones 404. In addition to audio, video can be displayed on a display 412. During the presentation of media, the user 402 can request to be presented with external sound 406 by pressing, for example, a pause button in accordance with one embodiment of the invention. As a result of pressing the pause button, the audio portion of media being presented via the headphones 404 is stopped or reduced to a determined level so that external sound 406 can be presented via the set of headphones 404. In other words, external sound 406, either alone or in combination of audio, is presented to user via the headphones 404 upon request. It should be noted that the user 402 can also be presented with external sound 406 after it has been stored as digital data. In other words, external sound 406 can be effectively recorded and subsequently presented to the user 402. As noted above, stored external sound can be presented with a full range of media playback features (e.g., forward, backward, pause, replay). It should be noted that the external sound 406 can be received via a microphone 420. Furthermore, the user 402 can control/adjust the presentation of external sound 406 by using a input/controller 422 provided on the same input line 430 of the media player too.

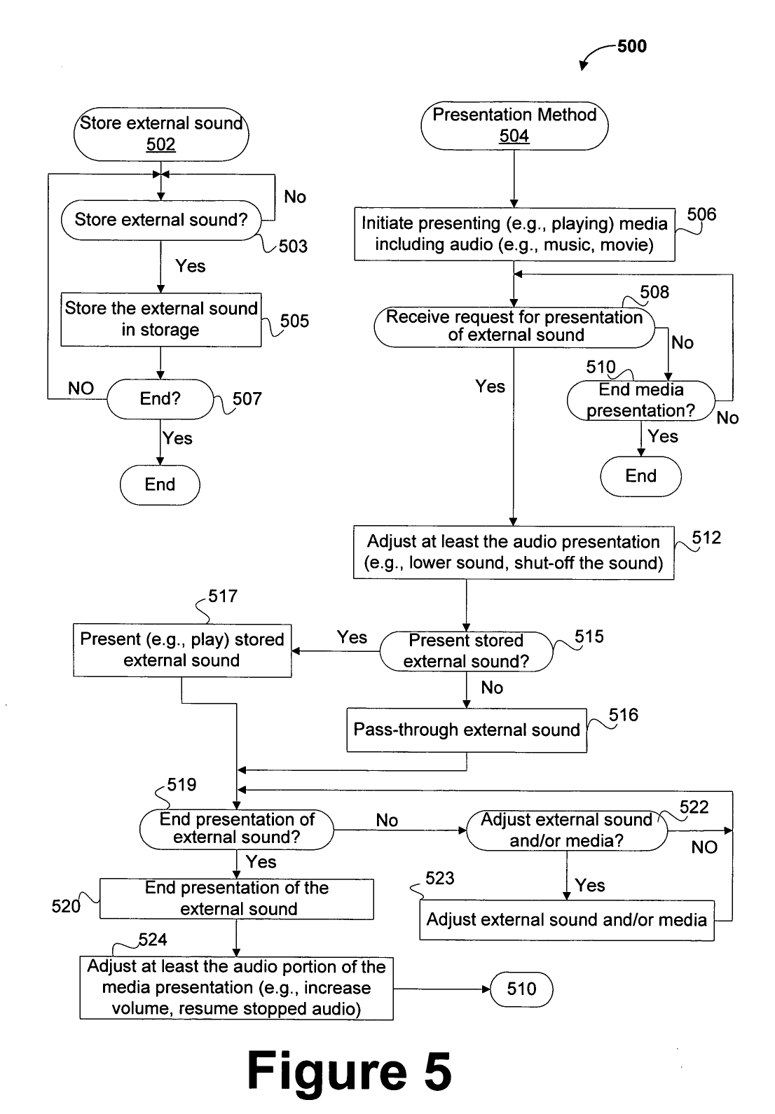

FIG. 5 depicts a method 500 for presenting external sound and media in accordance with one embodiment of the invention. Method 500 can, for example, be used by the media player 400 shown in FIG. 4. As shown in FIG. 5, external sound con be stored (502) independent of the presentation of media and/or external sound (presentation method 502). Generally, external sound can be stored (505) when it is determined (503) to store the external sound. It will be appreciated that this determination can, for example, be made based on a timer, when external sound is detected, or external sound can be recorded continuously or any other programmable criteria. In general, any programmable condition or criteria, or event or input can be used to determine whether to store the external sound. Similarly, storing (503) of the external sound can effectively end (507), for example, when no external sound is detected, user input requests ending the storing of external sound, or a timer expires.

Independent of the storing of me external sound, presentation method 504 can present media and/or external sound. More particularly, the presentation method 504, initially initiates presenting 506 (e.g., playing music, movie) media that includes at least audio (an audio-portion). Next, it is determined (508) whether a request for presentation of external sound is received. A request can, for example, be made by pressing an input key (e.g., pause button). Similarly, a request can be made to end the media presentation or effectively cancel the request for presentation of media. As such, the presentation method 504 ends if it is determined (510) to end the media presentation. Alternatively, media presentation can effectively continue until a request for presentation of external sound is received.

When it is determined (508) that a request for presentation of external sound is received, at least the audio-portion of the presentation is adjusted (512) (e.g., volume of the audio-portion is lowered or completely shut-off). Next, it is determined (515) whether to present external sound that has been stored. Accordingly, external sound which has been stored can be presented (517) (e.g., played). However, if it is determined (515) not to present external sound that has been stored, external sound is passed through and presented (516). In other words, external sound is effectively presented as it occurs (i.e., live presentation). The presentation method 504 ends when it is determined (510) to end the presentation of the media.

It will be appreciated that both pass-through (i.e., sound current) (516) and stored external sound (517) can be presented. The presentation of external sound ends (520) if it is determined (519) to end the presentation of external sound (e.g., user input, timer, indicates to end the presentation, external sound is no longer detectable). However, if it is determined (519) not to end the presentation of the external sound, it is determined (522) whether to adjust the presentation of external sound and/or media. Similarly, user input, a timer, automatic detection of the external sound level can, for example, be used to determine (522) whether to adjust the external sound and/or media. Accordingly, external sound and/or media is adjusted (523) and it determined (519) whether to end presentation of the external sound. This determination (519) can, for example, be made based on user input or any programmable criteria. It should be noted that after ending (520) the presentation of external sound, the audio portion of the media presentation is typically adjusted (524) (e.g., volume is increased, audio which was stopped is resumed). As noted above, presentation method 504 ends when it is determined (510) to end it.

What is claimed is

1. A method for presentation of audio by a device, said method comprising:
determining whether to present sound that can be effectively blocked or reduced by said device; and
presenting, by said device, said sound when said determining determines to present said sound.

2. A method as recited in claim 1,
wherein said device is capable of presenting at least an audible media capable of being stored on a computer readable medium, and
wherein said sound is or would be external sound with respect to said audible media.

3. A method as recited in claim 2, wherein said presenting of said sound presents said sound and said audible media together.

4. A method as recited in claim 3, wherein said presenting of said sound presents said sound and said audible media together over the same interface, output-device or channel, thereby effectively combining said sound and audible media together.

5. A method as recited in claim 2, wherein said method further comprises:
determining whether audible media is being presented or is to be presented with said sound when said determining determines to present said sound.

6. A method as recited in claim 1, wherein said presenting of said sound presents said sound and said audible media together over the same interface, output-device or channel in accordance with input received from a user of said device.

7. A method as recited in claim 2, wherein said method further comprises:
determining whether to adjust said audible media when said determining determines that said audible media is being presented; and
adjusting presentation of said audible media when said determining determines to adjust said audible media.

8. A method as recited in claim 7, wherein said method further comprises:
presenting said audible media and said sound together after said adjusting of said presentation of said audible media.

9. A method as recited in claim 7, wherein said adjusting of presentation of said audible media presentation comprises: adjusting volume of audio associated with said audible media when said media is presented.

10. A method as recited in claim 9, wherein said adjusting of presentation of said audible media presentation comprises: reducing said volume of audio associated with said audible media when said media is presented.

11. A method as recited in claim 10, wherein said adjusting of presentation of said audible media presentation comprises: stopping or pausing said presentation of audible media.

12. A method as recited in claim 1, wherein said determining of whether to present sound that can be effectively blocked or reduced by said device is made based on input received from a user of said device.

13. A method as recited in claim 1, wherein said sound is one or more of the following: noise, sound of traffic, people conversing, audio output by another device, and natural sounds.

14. A method as recited in claim 1, wherein said method further comprises:
determining whether to store said sound; and
storing said sound as stored sound when said determining determines to store said sound.

15. A method as recited in claim 11, wherein said method further comprises:
determining whether to present said stored sound; and
presenting said stored-sound when said determining determines to present said stored sound.

16. A method as recited in claim 12, determining whether to present said stored sound with said available media; and
presenting said stored-sound with said available media when said determining determines to present said stored sound with said available media.

17. A method for presentation of media by a media player capable of presenting at least audible media stored in a computer readable medium, said method comprising:
initiating presentation of said audible media, wherein said presentation of said audible media at least reduces external sound that is external to said presentation of audible media;
receiving input initiated by a user of said media player, wherein said input effectively requests presentation of said external sound;
presenting, by said media player, said external sound after receiving said input from said user.

18. A method as recited in claim 17, wherein said user inputs said input by pressing a pause button that effectively causes presentation of said audible media to pause.

19. A method as recited in claim 17, wherein method further comprises:
pausing said audible media, and
presenting said external sound instead of said audible media.

20. A method as recited in claim 19, wherein said method further comprises:
adjusting said audible media to accommodate presentation of external sound, and
presenting the combination of said audible media with said external sound together.

21. A media player that is capable of presenting media including audible media that can be stored in a computer readable medium, wherein said media player is operable to:
initiate presentation of said audible media, wherein said presentation of said audible media at least reduces external sound that is external to said presentation of audible media;
receive input initiated by a user of said media player, wherein said input effectively requests presentation of said external sound;
present, by said media player, said external sound after receiving said input from said user.

22. A device for presentation of audio, wherein said device is operable to:
determine whether to present sound that can be effectively blocked or reduced by said device; and
present said sound when said determining determines to present said sound.

23. A computer readable medium including computer program code for presentation of audio, wherein said computer readable medium comprises:
computer program code for determining whether to present sound that can be effectively blocked or reduced by said device; and
computer program code for presenting said sound when said determining determines to present said sound.
